(19) United States
(12) Patent Application Publication
(10) Pub. No.: US 2006/0270511 A1
(43) Pub. Date: Nov. 30, 2006

(54) Differential gear apparatus

(75) Inventors: Lung-Chang Hsieh, Chang Hua Hsien (TW); Shinn-Liang Chang, Chia Yi City (TW); Kuo-Yung Ko, Taichung City (TW)

Correspondence Address: BROOKS KUSHMAN P.C., 1000 TOWN CENTER, TWENTY-SECOND FLOOR, SOUTHFIELD, MI, 48075, US

(73) Assignee: Sunpex Technology Co., Ltd., Chia Yi City (TW)

(21) Appl. No.: 11/136,048

(22) Filed: May 24, 2005

(51) Int. Cl. F16H 48/06

(52) U.S. Cl. 475/230

(57) ABSTRACT

A differential gear apparatus includes a housing, left and right shafts respectively having journal ends disposed in the housing and rotatable relative to the housing about a central axis to rotate wheels of a vehicle, a ring gear received in the housing and driven by a motor to rotate about the central axis relative to the housing, a central mount disposed at the center of the ring gear to be rotated therewith. Front and rear differential pinions and left and right bevel gears are journalled on front and rear bearing members on the central mount and left and right anti-frictional bearings in the housing, respectively. Each of the left and right bevel gears meshes with both the front and rear differential pinions, and is rotated with a respective one of the shafts so as to transmit rotational force thereto.

### BACKGROUND OF THE INVENTION

1. Field of the Invention

This invention relates to a differential gear apparatus, more particularly to a differential gear apparatus which receives a drive for transfer to left and right wheels of a wheeled vehicle.

2. Description of the Related Art

Referring to FIG. 1, a conventional differential gear apparatus is shown to include a housing 13, a gear unit 14 received in an accommodation portion 131 of the housing 13 and driven by an electrically powered motor 11, left and right shafts 15 received in left and right sleeve portions 132 of the housing 13, and a plurality of anti-frictional bearings 16 sleeved on the respective left and right shafts 15 and fitted into the respective left and right sleeve portions 132 such that the left and right shafts 15 are rotatable with the gear unit 14 relative to the housing 13 by means of the motor 11. However, since the gear unit 14 is supported by the left and right shafts 15 in the accommodation portion 131, and i.e. suspended in the housing 13, the weight of the gear unit 14 will create a torque on the left and right shafts 15, thereby undesirably increasing the load borne by the left and right shafts.

### SUMMARY OF THE INVENTION

The object of the present invention is to provide a differential gear apparatus that can reduce loads applied to left and right shafts upon which wheels of a vehicle are mounted.

According to this invention, the differential gear apparatus includes a housing defining a central axis in the axial direction, and left and right shafts respectively having left and right journal ends which are disposed in and which are rotatable relative to the housing about the central axis and which are spaced apart from each other along the central axis, and left and right driving ends which are opposite to the left and right journal ends, respectively, along the central axis, and which extend outwardly of the housing. A ring gear is received in the housing, and has an outer toothed rim portion adapted to be driven by a motor to rotate about the central axis relative to the housing, and an inner rim portion opposite to the outer toothed rim portion radially and defining a center at the central axis. A central mount is disposed at the center of the inner rim portion to be rotated with the ring gear. Front and rear bearing members are disposed on the central mount, and are opposite to each other along a transverse axis that is transverse to and that intersects the central axis at the center of the inner rim portion. Front and rear differential pinions are journalled on the front and rear bearing members, respectively. Left and right bevel gears mesh with the front and rear differential pinions. Each of the left and right bevel gears has a tubular coupling portion coupled with a respective one of the left and right journal ends so as to enable the left and right bevel gears to be rotated with the respective left and right journal ends, thereby transmitting rotational force thereto. Left and right anti-frictional bearings are disposed between the tubular coupling portions of the left and right bevel gears and the housing to facilitate rotation of the left and right bevel gears relative to the housing about the central axis.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a fragmentary perspective view of a conventional differential gear apparatus;

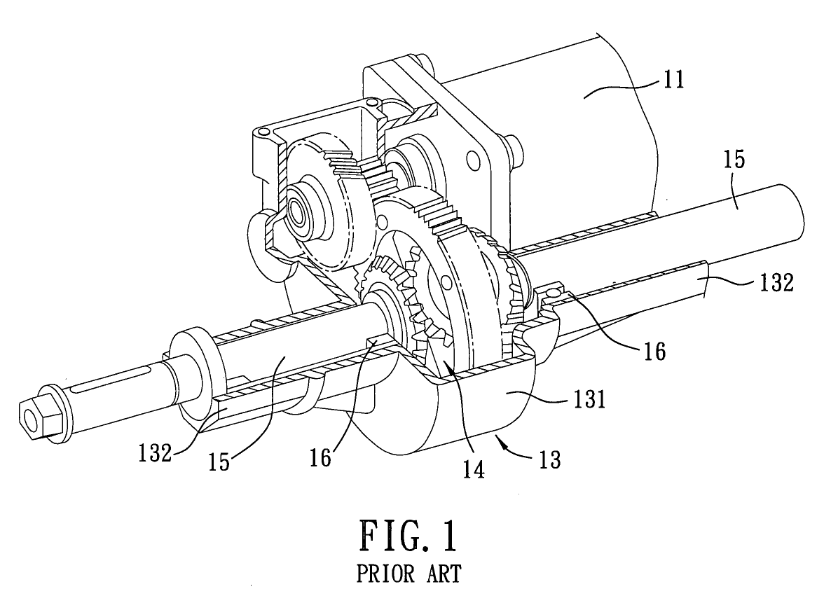

FIG. 2 is a perspective view of the preferred embodiment of a differential gear apparatus according to this invention;

FIG. 3 is an exploded perspective view of the preferred embodiment;

FIG. 4 is fragmentary cross-sectional view of the preferred embodiment;

FIG. 5 is a fragmentary sectional view of the preferred embodiment;

FIG. 6 is a partly cross-sectional view of the preferred embodiment taken along lines VI-VI of FIG. 4; and

FIG. 7 is a fragmentary sectional view of the preferred embodiment taken from another angle.

### DETAILED DESCRIPTION OF THE PREFERRED EMBODIMENT

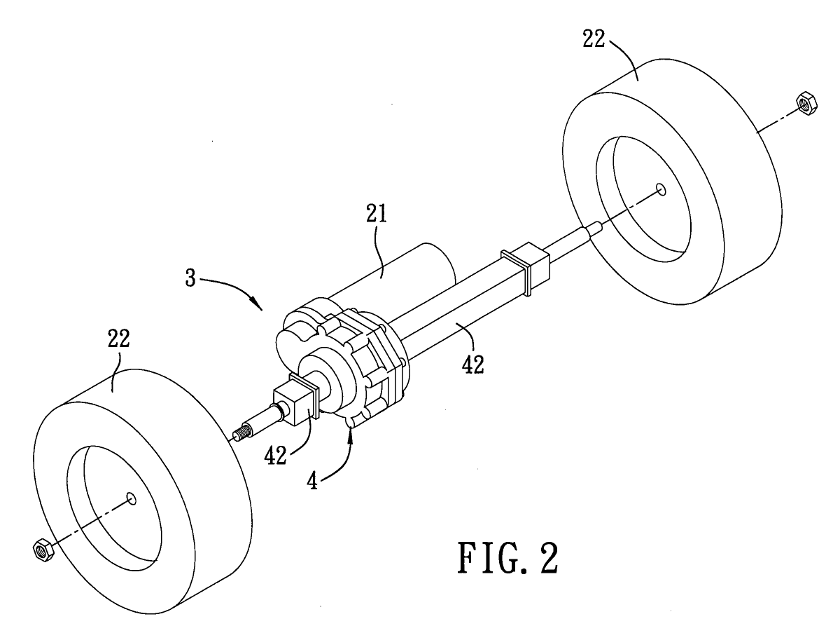

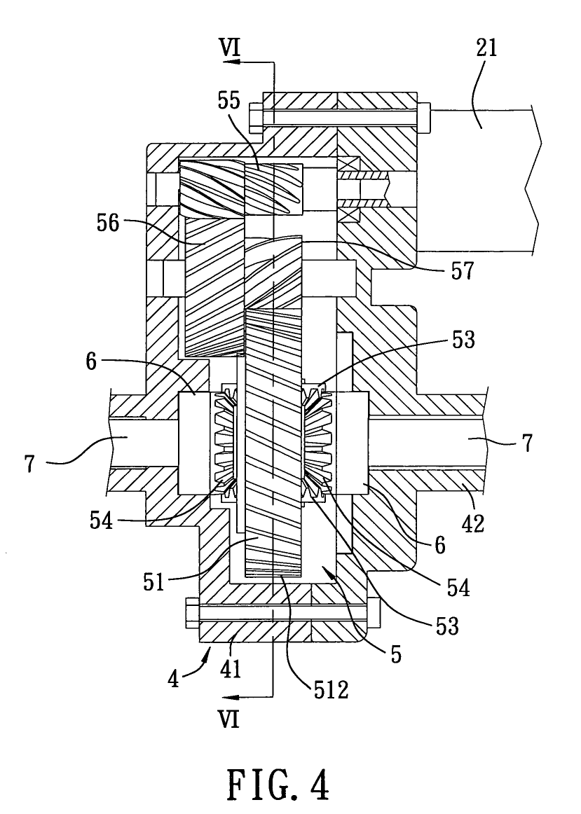

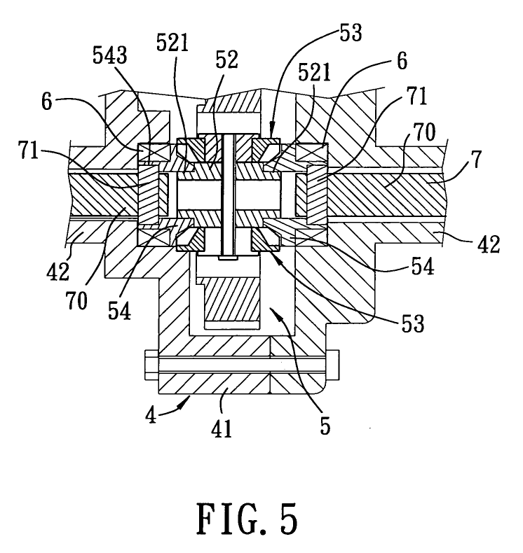

Referring to FIGS. 2 to 5, the preferred embodiment of a differential gear apparatus 3 according to the present invention is adapted to be mounted in an electrically powered vehicle (not shown), and is driven by an electrically powered motor 21 to transfer a drive to left and right wheels 22. The differential gear apparatus 3 is shown to comprise a housing 4, left and right shafts 7, and a gear unit 5. The housing 4 includes an accommodation portion 41 and left and right sleeve portions 42, and defines a central axis in the axial direction.

The left and right shafts 7 respectively have left and right journal ends 70 which are disposed in and which are rotatable relative to the left and right sleeve portions 42, respectively, about the central axis and which are spaced apart from each other along the central axis, and left and right driving ends 72 which are opposite to the left and right journal ends 70, respectively, along the central axis, and which extend outwardly of the left and right sleeve portions 42 so as to be rotated with the left and right wheels 22, respectively.

The gear unit 5 includes a ring gear 51, a central mount 52, front and rear differential pinions 53, and left and right bevel gears 54.

The ring gear 51 is received in the accommodation portion 41, and which has an outer toothed rim portion 512 and an inner rim portion 513 opposite to the outer toothed rim portion 512 radially and defining a center at the central axis. A pinion mechanism includes a pinion shaft 55 which is coupled with and which is driven by the electrically powered motor 2l, a large gear 56 which meshes with the pinion shaft 55, a small gear 57 which is coaxially rotated with the large gear 56 and which meshes with the outer toothed rim portion 512 of the ring gear 51 such that the ring gear 51 can receive a drive torque which rotates the ring gear 51 about the central axis and which is transferred to the left and right shafts 7. The inner rim portion 513 has two engaging grooves 511 formed diametrically opposite to each other.

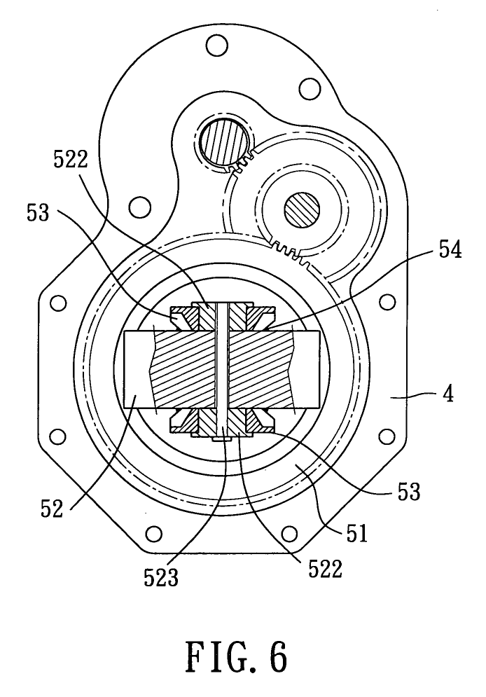

The central mount 52 is in the form of a block which extends along a diametrical line transverse to the central axis to terminate at two engaging ends that are fitted respectively into the engaging grooves 511 in the axial direction so as to enable the central mount 52 to be rotated with the ring gear 51. Left and right bearing members 521 are integrally formed with and extend from the central mount 52, and are disposed opposite to each other along the central axis. Front and rear bearing members 522 are tightened on the central mount 52 by means of a tightening member 523, such as a screw fastener as shown in FIG. 6, so as to be aligned along a transverse axis that is transverse to both the central axis and the diametrical line and that intersects the central axis at the center of the inner rim portion 513 of the ring gear 51.

The front and rear differential pinions 53 are journalled on the front and rear bearing members 522, respectively. The left and right bevel gears 54 respectively have bevel gear portions 541 which are journalled on the left and right bearing members 521, respectively, and tubular coupling portions 542 which are coaxial with the bevel gear portions 541 and which extend respectively from the left and right bearing members 521, each of the tubular coupling portions 542 has an inner surrounding coupling surface which surrounds the central axis, and a pair of key slots 543 which are formed in the inner surrounding coupling surface and which extend in the axial direction. Each of the left and right journal ends 70 is formed with a pair of keys 71 which are disposed to engage the key slots 543, respectively, so as to bring the respective one of the left and right journal ends 70 into a splined engagement with the respective one of the tubular coupling portions 542. Thus, the tubular coupling portions 542 can couple with the left and right journal ends 72 of the left and right shafts 7, respectively, so as to be rotated therewith. Each of the left and right bevel gears 54 meshes with both the front and rear differential pinions 53. By virtue of the left and right bearing members 521, the rotation of the left and right bevel gears 54 is stabilized.

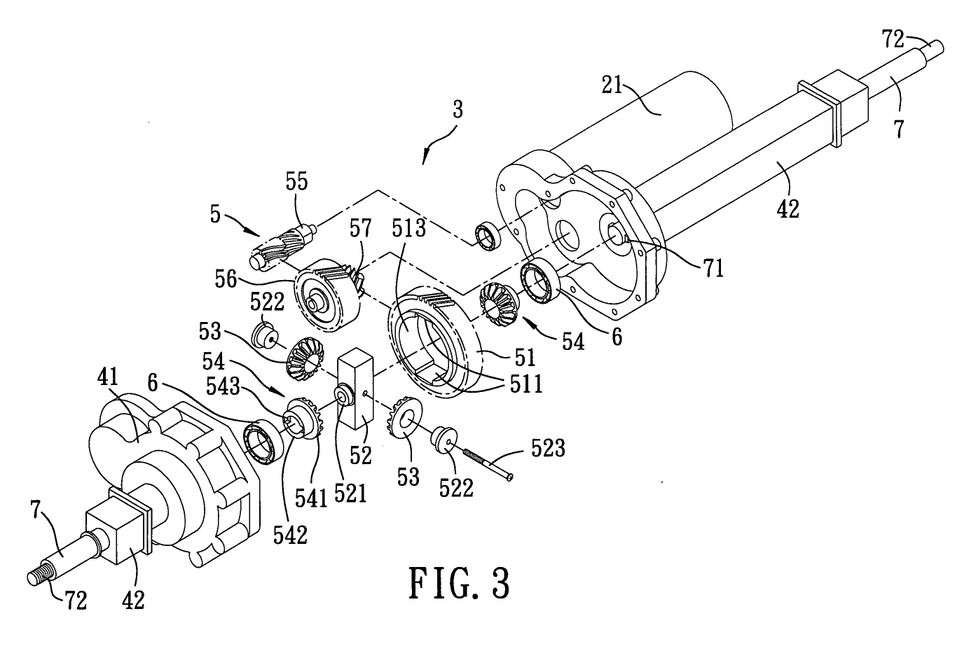

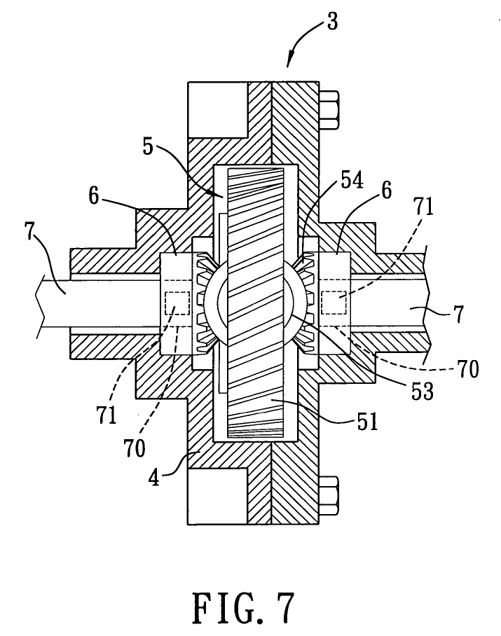

As shown in FIGS. 3 and 7, a left anti-frictional bearing 6 is disposed between the tubular coupling portion 542 of the left bevel gear 54 and the left sleeve portion 42. A right anti-frictional bearing 6 is disposed between the tubular coupling portion 542 of the right bevel gear 54 and the right sleeve portion 42 so as to facilitate the rotation of the respective one of the left and right bevel gears 54 relative to the housing 4 about the central axis.

When the pinion shaft 55 is driven by the motor 21 to drive the ring gear 51 to rotate about the central axis through the large and small gears 56, 57, the rotational force is transmitted to the left and right shafts 7 by means of the front and rear differential pinions 53 and the left and right bevel gears 54 to rotate the left and right wheels 22 so as to move the vehicle forwards. When the vehicle changes the traveling direction, e.g., turns around a corner, rotation of the front and rear differential pinions 53 about the transverse axis results in speed difference of the left and right bevel gears 54 so as to rotate the left and right wheels 7 at different speeds in a known manner.

As illustrated, the left and right bevel gears 54 can be rotatably supported in the housing 4 by virtue of the left and right anti-frictional bearings 6, and are journalled on the left and right bearing members 521 such that the left and right bevel gears 54 can be positioned along the central axis. That is, the ring gear 51, the front and rear differential pinions 53 and the left and right bevel gears 54 are mounted in the housing 4 by means of the left and right anti-frictional bearings 6 such that the weight of the ring gear 51, the central mount 52, the front and rear differential pinions 53 and the left and right bevel gears 54 are borne by the housing 4 instead of the left and right shafts 7. Therefore, the torque borne by the left and right shafts 7 can be relatively reduced.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

We claim:

1. A differential gear apparatus comprising:
a housing defining a central axis in the axial direction;
left and right shafts respectively having left and right journal ends which are disposed in and which are rotatable relative to said housing about the central axis and which are spaced apart from each other along the central axis, and left and right driving ends which are opposite to said left and right journal ends, respectively, along the central axis, and which extend outwardly of said housing;
a ring gear which is received in said housing, and which has an outer toothed rim portion adapted to be driven by a motor to rotate about the central axis relative to said housing, and an inner rim portion opposite to said outer toothed rim portion radially and defining a center at the central axis;
a central mount which is disposed at the center of said inner rim portion to be rotated with said ring gear;
front and rear bearing members which are disposed on said central mount and which are opposite to each other along a transverse axis that is transverse to and that intersects the central axis at the center of said inner rim portion;
front and rear differential pinions journalled on said front and rear bearing members, respectively;
left and right bevel gears, each of which meshes with said front and rear differential pinions, each of said left and right bevel gears having a tubular coupling portion which is coupled with a respective one of said left and right journal ends so as to enable the respective one of said left and right bevel gears to be rotated with the respective one of said left and right journal ends, thereby transmitting rotational force thereto; and
left and right anti-frictional bearings, each of which is disposed between said tubular coupling portion of a respective one of said left and right bevel gears and said housing to facilitate rotation of the respective one of said left and right bevel gears relative to said housing about the central axis.

2. The differential gear apparatus of claim 1, further comprising left and right bearing members which are disposed on said central mount and which are opposite to each other along the central axis, each of said left and right bevel gears having a bevel gear portion which is coaxial with said tubular coupling portion, which extends away from the respective one of said left and right journal ends, and which is journalled on a respective one of said left and right bearing members.

3. The differential gear apparatus of claim 2, wherein said tubular coupling portion of each of said left and right bevel gears has an inner surrounding coupling surface surrounding the central axis, and a pair of key slots formed in said inner surrounding coupling surface and extending in the axial direction, each of said left and right journal ends being formed with a pair of keys disposed to engage said key slots, respectively, so as to bring the respective one of said left and right journal ends into a splined engagement with said tubular coupling portion.

4. The differential gear apparatus of claim 1, wherein said inner rim portion has two engaging grooves formed diametrically opposite to each other, said central mount extending along a diametrical line transverse to both the central axis and the transverse axis to terminate at two engaging ends which are configured to be fitted into said engaging grooves in the axial direction so as to enable said central mount to be rotated with said ring gear.

5. The differential gear apparatus of claim 2, wherein each of said left and right bearing members extends along the axis and is integrally formed with said central mount.

6. The differential gear apparatus of claim 1, further comprising a tightening member disposed to tighten said front and rear bearing members to said central mount so as to align said front bearing member with said rear bearing member along the transverse axis.
